(19) United States
(12) Patent Application Publication
(10) Pub. No.: US 2009/0249354 A1
(43) Pub. Date: Oct. 1, 2009

(54) RECORDING MEDIUM HAVING RECORDED THEREIN VIRTUAL MACHINE MANAGEMENT PROGRAM, MANAGEMENT SERVER APPARATUS AND VIRTUAL MACHINE MANAGEMENT METHOD

(75) Inventors: Hiroyuki Yamaguchi, Kawasaki (JP); Takashi Maeda, Kawasaki (JP); Yuta Kojima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/409,603

(22) Filed: Mar. 24, 2009

(30) Foreign Application Priority Data
Mar. 31, 2008 (JP) 2008-93078

(51) Int. Cl. G06F 9/46; G06F 9/455

(52) U.S. Cl. 718/106; 718/1

(57) ABSTRACT

A virtual machine managing method includes: virtual machine list generation step of detecting a plurality of virtual machines deployed on a physical machine; a dependency list generation step of detecting dependencies among the virtual machines deployed on the physical machine; a power-off order generation step of, based on table contents of the virtual machine list table and the dependency list table, generating a power-off order management table which manages a power-off order in which the same virtual machines are sequentially powered off in descending order of dependency, in units of the physical machine; and a target presentation step of, when an instruction for selecting the power-off target physical machine is detected, reading the power-off order corresponding to this power-off target physical machine from the power-off order management table, and visually presenting this read power-off order.

### CROSS-REFERENCE TO RELATED APPLICATION

This application is based upon and claims the benefit of priority of the prior Japanese Patent Application No. 2008-93078, filed on Mar. 31, 2008 the entire contents of which are incorporated herein by reference.

### FIELD

The present invention relates to a recording medium having recorded therein a virtual machine management program for causing a computer apparatus which causes arbitrary virtual machines among a plurality of virtual machines deployed on a physical machine such as, for example, a host machine to execute a control process in cooperation with one another, to execute a process of managing the above described plurality of virtual machines, as well as a management server apparatus and a virtual machine management method.

### BACKGROUND

Conventionally, as such a management server apparatus, there is a well-known technique for managing a physical machine such as, for example, a host machine, and also using virtualization software to manage a plurality of virtual machines deployed on this physical machine, and enabling arbitrary virtual machines among the plurality of virtual machines to execute one control process in cooperation with one another (for example Japanese Patent Laid-Open No. 6-250858).

Moreover, in such a management server apparatus which deploys the plurality of virtual machines on the physical machine, there are known a technique for separating a processing resource of a virtual machine in response to loss of the same virtual machine, and a technique for determining whether or not there is an additional partition when power-off of a logical partition is requested, and based on a result of this determination, executing the power-off or shut-down (for example National Publication of International Patent Application No. 2004-523048).

According to such a conventional management server apparatus, if the physical machine is powered off, all the virtual machines deployed on the physical machine of a power-off target need to be powered off in a software manner before this physical machine is powered off. However, of course, cooperative relationships, that is, dependencies among the virtual machines deployed on this power-off target physical machine can be comprehended only by a specific system administrator, and in addition, the virtual machines dynamically move on the physical machine. Therefore, when the power-off target physical machine is powered off, it is very difficult to identify an order in which all the virtual machines having the dependencies should be powered off in a software manner, and in addition, when a user other than the specific system administrator powers off the power-off target physical machine, a complicated operational burden is necessarily imposed on the user.

### SUMMARY

This program is a virtual machine management program for causing a computer apparatus which causes arbitrary virtual machines among a plurality of virtual machines deployed on a physical machine to execute a control process in cooperation with one another, to execute a process of managing the above described plurality of virtual machines. One feature of the virtual machine management program is to cause the above described computer apparatus to execute a virtual machine list generation procedure for detecting the virtual machines deployed on the above described physical machine, and based on a result of this detection, generating a virtual machine list table which manages, in units of physical machine identification information for identifying the above described physical machine, virtual machine identification information for identifying the virtual machines deployed on this physical machine; a dependency list generation procedure for detecting dependencies among the virtual machines deployed on the above described physical machine, and based on a result of this detection, generating a dependency list table which manages, in units of the virtual machine identification information on the above described virtual machines, the virtual machine identification information on the virtual machines having the dependencies on the same virtual machines; a power-off order generation procedure for, based on table contents of the above described virtual machine list table and the above described dependency list table, from the virtual machines deployed on the physical machine of a power-off target and the virtual machines having the dependencies on these virtual machines, generating a power-off order management table which manages a power-off order in which the same virtual machines are sequentially powered off in descending order of dependency, in units of the above described physical machine; and a target presentation procedure for, when an instruction for selecting the above described power-off target physical machine is detected, reading the power-off order corresponding to this power-off target physical machine from the above described power-off order management table, and visually presenting this read power-off order.

The object and advantages of invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram depicting a schematic configuration of an entire virtual machine management system of the present embodiment;

FIG. 2 is a block diagram depicting a schematic internal configuration of a management server which is a main portion of the present embodiment;

FIG. 3 is an explanatory diagram briefly depicting an example of dependencies among virtual machines deployed on physical machines in the present embodiment;

FIG. 4 is an explanatory diagram briefly depicting table contents of a virtual machine list table in the present embodiment;

FIG. 5 is an explanatory diagram briefly depicting table contents of a dependency list table (the dependencies depicted in FIG. 3) in the present embodiment;

FIG. 6 is an explanatory diagram briefly depicting an operation when a first place in a power-off order is set by using the virtual machine list table and the dependency list table in the present embodiment;

FIG. 7 is an explanatory diagram briefly depicting an operation when a second place and subsequent places in the power-off order are set by using the dependency list table in the present embodiment;

FIG. 8 is an explanatory diagram briefly depicting table contents of a power-off order management table in the present embodiment;

FIG. 9 is a flowchart depicting a processing operation of a server management control unit within the management server, regarding a virtual machine management process in the present embodiment;

FIG. 10 is a flowchart depicting a processing operation of the server management control unit within the management server, regarding a power-off order setting process in the present embodiment;

FIG. 11 is an explanatory diagram briefly depicting an example of the dependencies among the virtual machines deployed on the physical machines in the present embodiment;

FIG. 12 is a flowchart depicting a processing operation of the server management control unit within the management server, regarding a physical machine power-off process in the present embodiment;

FIG. 13 is an explanatory diagram briefly depicting a power-off command screen at the time of the physical machine power-off process, which is presented to a client side in the present embodiment; and

FIG. 14 is an explanatory diagram briefly depicting the power-off command screen (power-off order screen) at the time of the physical machine power-off process, which is presented to the client side in the present embodiment.

### DESCRIPTION OF EMBODIMENT

Hereinafter, an embodiment regarding a virtual machine management program, a management server apparatus and a virtual machine management method of the present invention will be described in detail based on the drawings.

First, a summary of the present embodiment will be described. As the summary thereof, when an instruction for selecting power-off with respect to a physical machine is detected, from virtual machines deployed on the physical machine of a power-off target and virtual machines having dependencies on these virtual machines, a power-off order in which the same virtual machines are sequentially powered off in descending order of dependency is visually presented. Therefore, even a user other than a specific system administrator can identify the power-off order in the power-off target physical machine based on presented contents thereof, and thereby easily power off the power-off target physical machine including the virtual machines dependent on the power-off target physical machine, without any complicated operational burden.

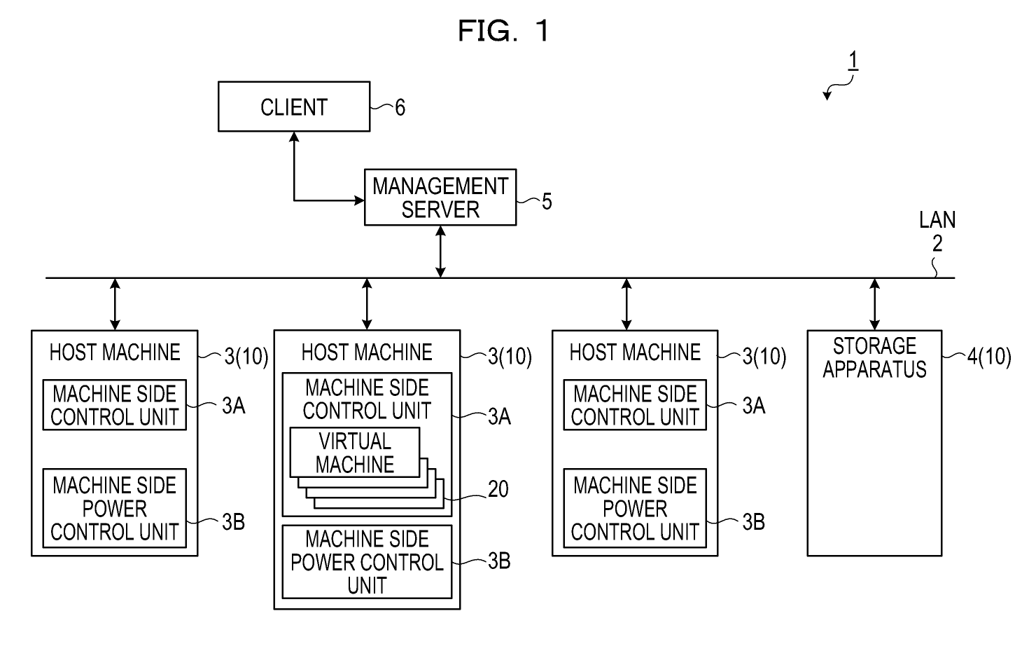

FIG. 1 is a block diagram depicting a schematic configuration of an entire virtual machine management system of the present embodiment.

A virtual machine management system 1 depicted in FIG. 1 includes a management server 5 which manages a plurality of host machines 3 and a storage apparatus 4 via a LAN 2, and a client 6 which operates this management server 5. The host machine 3 includes a machine side control unit 3A which controls the entire host machine 3, and a machine side power control unit 3B which takes charge of power control of this host machine 3.

The host machine 3 uses virtualization software to deploy a plurality of virtual machines 20 on the machine side control unit 3A, and causes the plurality of virtual machines 20 being deployed, to execute various processes in cooperation with one another.

Moreover, the management server 5 manages physical machines 10 such as the host machine 3 and the storage apparatus 4, and also uses a management tool of the virtualization software to manage the plurality of virtual machines 20 deployed on the physical machines 10.

Moreover, the management server 5 uses power control software to manage powers of the virtual machines 20 deployed on the physical machines 10, in a software manner.

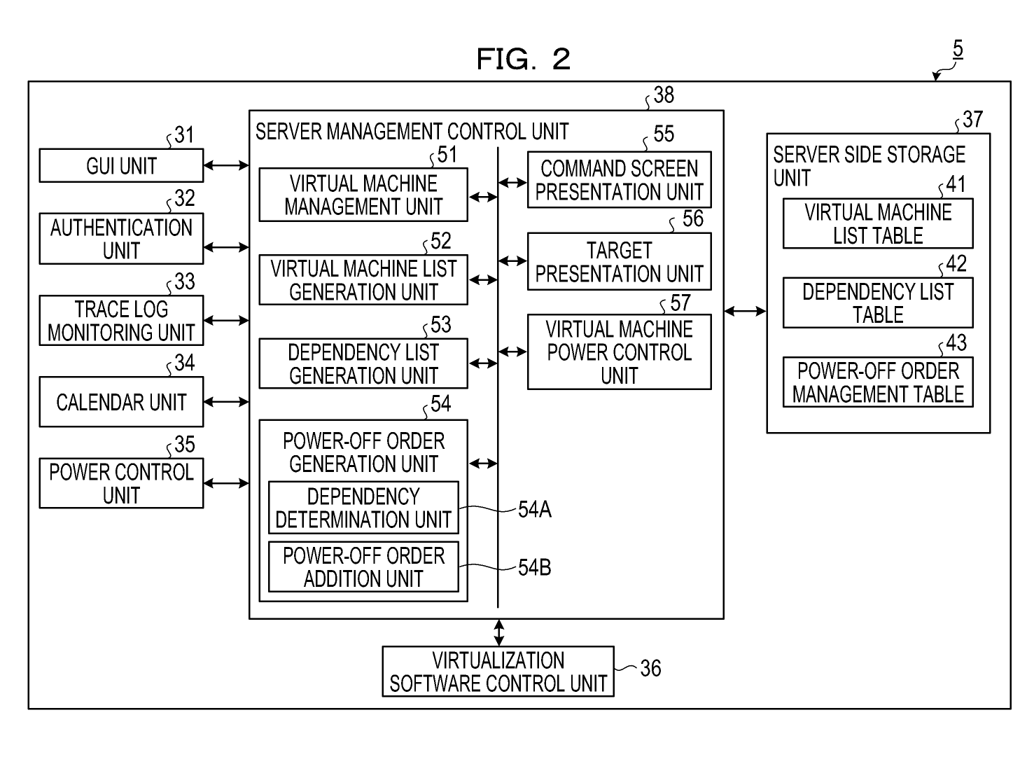

FIG. 2 is a block diagram depicting a schematic internal configuration of the management server 5 of the present embodiment.

The management server 5 depicted in FIG. 2 includes a GUI (Graphical User Interface) unit 31 which takes charge of a user interface with the client 6, an authentication unit 32 which cooperates with the management tool of the virtualization software to execute an authentication process, a trace log monitoring unit 33 which manages information collected when a failure occurs and an operational history of an audit trail, a calendar unit 34 which takes charge of a calendar function, and a power control unit 35 which takes charge of power control of, of course, the same management server 5, and each physical machine 10.

The power control unit 35 performs the power control of each physical machine 10 through the machine side power control unit 3B of each physical machine 10.

Moreover, the management server 5 includes a virtualization software control unit 36 which uses the management tool of the virtualization software to monitor and control the plurality of virtual machines 20 deployed on the physical machines 10, a server side storage unit 37 which stores various information regarding the management server 5, and a server management control unit 38 which controls this entire management server 5.

The server side storage unit 37 includes a virtual machine list table 41 which manages, for each physical machine 10, the virtual machines 20 deployed on the same physical machine 10, in a list form in units of the physical machines 10, a dependency list table 42 which manages dependencies among the virtual machines 20, in the list form in units of the physical machines 10, and a power-off order management table 43 which manages, in units of the physical machines 10 of power-off targets, a power-off order of, of course, the virtual machines 20 deployed on the same physical machines 10, and the virtual machines 20 having the dependencies on these virtual machines 20.

It should be noted that although, for convenience of explanation, it is described that the physical machines 10 or the virtual machines 20 are managed in the virtual machine list table 41, the dependency list table 42 and the power-off order management table 43, these physical machines 10 and the virtual machines 20 are managed, of course, with physical machine identification information (PM) for identifying the same physical machines 10 and virtual machine identification information (VM) for identifying the virtual machines 20.

The server management control unit 38 includes a virtual machine management unit 51 which manages, for each physical machine 10, the virtual machines 20 deployed on the same physical machine 10, through the virtualization software control unit 36, a virtual machine list generation unit 52 which generates the virtual machine list table 41, a dependency list generation unit 53 which generates the dependency list table 42, and a power-off order generation unit 54 which generates the power-off order management table 43.

The virtual machine list generation unit 52 collects management information on the virtual machines 20 deployed on the physical machines 10, through the management tool of the virtualization software, via the virtualization software control unit 36, and generates the virtual machine list table 41 which manages, for each physical machine 10, the virtual machines 20 deployed on the same physical machine 10, in the list form. It should be noted that the management tool of the virtualization software periodically collects the management information on the virtual machines 20 deployed on the physical machines 10.

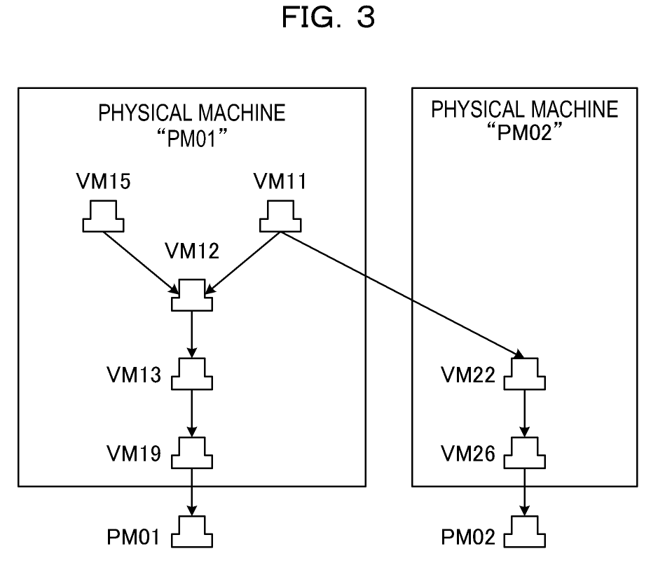

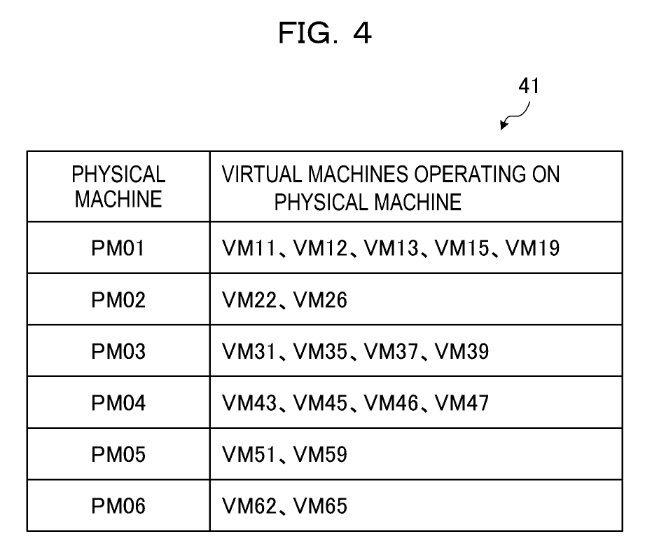

FIG. 3 is an explanatory diagram briefly depicting an example of the dependencies among the virtual machines 20 deployed on the physical machines 10 in the present embodiment, and FIG. 4 is an explanatory diagram briefly depicting table contents of the virtual machine list table 41 in the present embodiment.

As depicted in FIG. 3, on the physical machine 10 of “PM01”, five virtual machines 20 of “VM11”, “VM12”, “VM13”, “VM15” and “VM19” are being deployed, while on the physical machine 10 of “PM02”, two virtual machines 20 of “VM22” and “VM26” are being deployed.

Moreover, as their dependencies, on the physical machine 10 of “PM01”, the virtual machine 20 of “VM19” is not dependent on any other virtual machine 20, the virtual machine 20 of “VM13” is dependent on the virtual machine 20 of “VM19”, the virtual machine 20 of “VM12” is dependent on the virtual machine 20 of “VM13”, the virtual machine 20 of “VM15” is dependent on the virtual machine 20 of “VM12”, and the virtual machine 20 of “VM11” is dependent on the virtual machine 20 of “VM12”, and the virtual machine 20 of “VM22” on the physical machine 10 of “PM02”.

Moreover, on the physical machine 10 of “PM02”, the virtual machine 20 of “VM26” is not dependent on any other virtual machine 20, and the virtual machine 20 of “VM22” is dependent on the virtual machine 20 of “VM26”.

The virtual machine list table 41 depicted in FIG. 4 manages, for each physical machine 10, the virtual machines 20 deployed on the same physical machine 10, in the list form. As a result, based on the table contents of the virtual machine list table 41, the server management control unit 38 can recognize that, for example, on the physical machine 10 of “PM01”, the five virtual machines 20 of “VM11”, “VM12”, “VM13”, “VM15” and “VM19” are being deployed, while on the physical machine 10 of “PM02”, the two virtual machines 20 of “VM22” and “VM26” are being deployed.

Moreover, the dependency list generation unit 53 collects information on connection destinations among the virtual machines 20, through monitoring functions of the virtual machines 20 via the virtualization software control unit 36, and based on these collected connection states of the virtual machines 20, generates the dependency list table 42 which manages the information on the connection destinations among the virtual machines 20 in a one-to-one manner in the list form, in units of the physical machines 10. It should be noted that the monitoring function of the virtual machine 20 is installed in each virtual machine 20, and periodically confirms the information on the connection destinations among the virtual machines 20.

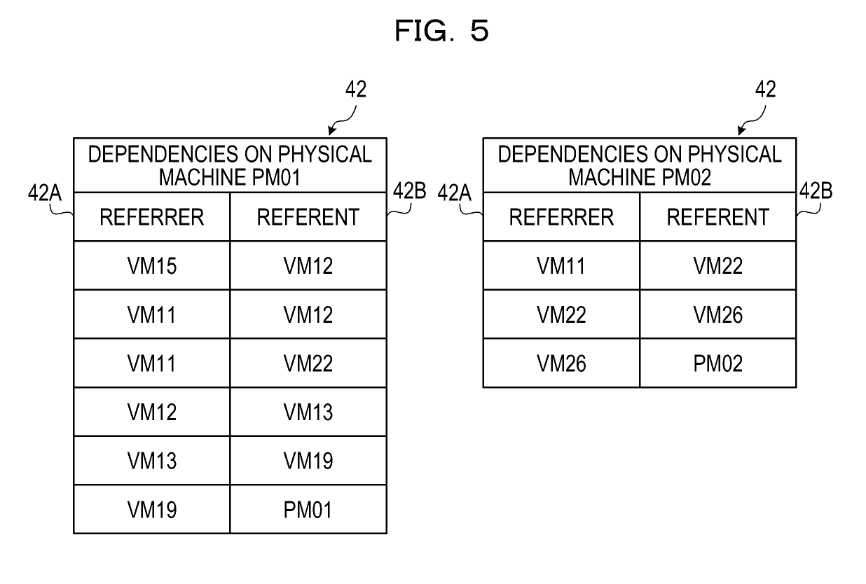

FIG. 5 is an explanatory diagram briefly depicting table contents of the dependency list table 42 (the dependencies depicted in FIG. 3) in the present embodiment.

The dependency list table 42 depicted in FIG. 5 manages the information on the connection destinations among the virtual machines 20 being deployed on each physical machine 10, as a referrer 42A and a referent 42B in a one-to-one manner in the list form, in units of the physical machines 10. As a result, based on the table contents of the dependency list table 42, the server management control unit 38 can recognize the dependencies among the virtual machines 20 in which, for example, between the virtual machine 20 of “VM15” and the virtual machine 20 of “VM12”, the virtual machine 20 of “VM15” is dependent on the virtual machine 20 of “VM12” (see FIG. 3), and therefore, the virtual machine 20 of “VM15” is the referrer 42A and the virtual machine 20 of “VM12” is the referent 42B, and for example, between the virtual machine 20 of “VM12” and the virtual machine 20 of “VM13”, the virtual machine 20 of “VM12” is dependent on the virtual machine 20 of “VM13” (see FIG. 3), and therefore, the virtual machine 20 of “VM12” is the referrer 42A and the virtual machine 20 of “VM13” is the referent 42B.

Moreover, based on the table contents of the virtual machine list table 41 depicted in FIG. 4 and the dependency list table 42 depicted in FIG. 5, the power-off order generation unit 54 generates the power-off order management table 43 which manages the power-off order of the virtual machines 20 in descending order of dependency, in units of the physical machines 10.

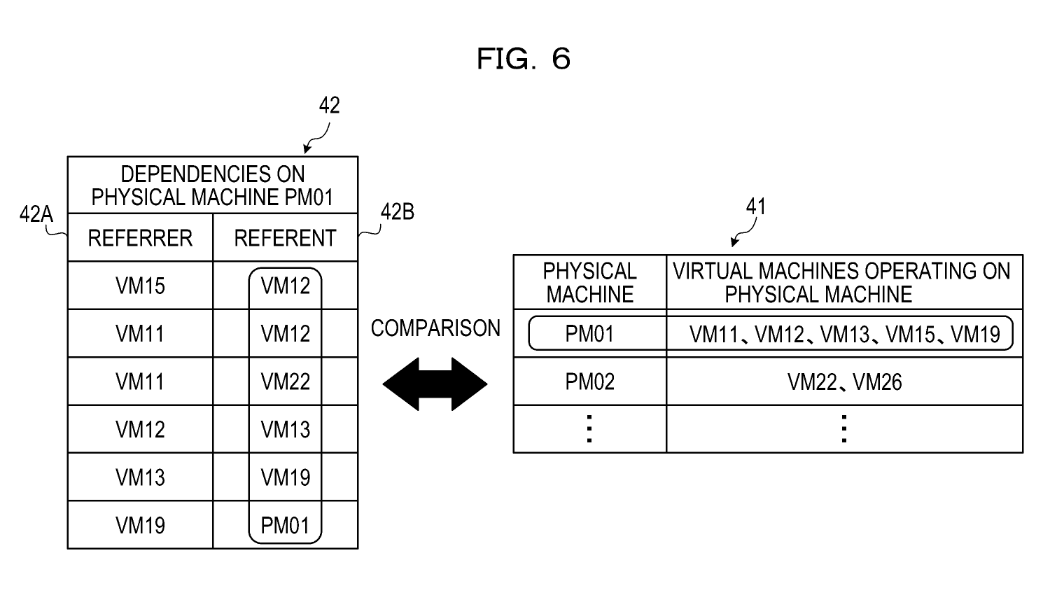

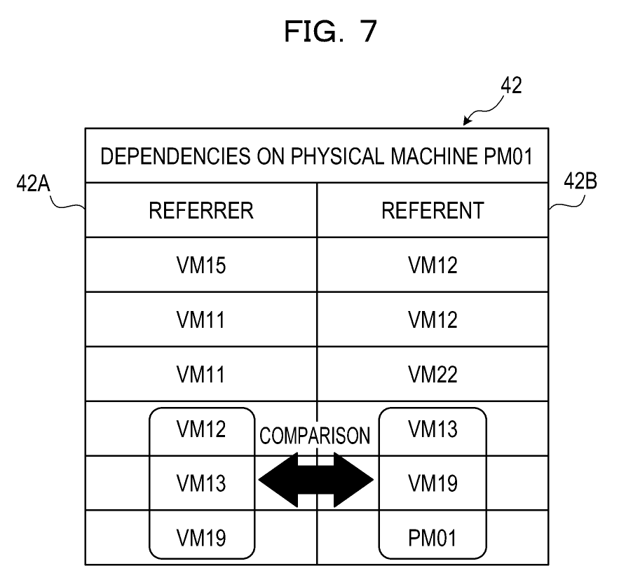

FIG. 6 is an explanatory diagram briefly depicting an operation when a first place in the power-off order is set by using the virtual machine list table 41 and the dependency list table 42 in the present embodiment, and FIG. 7 is an explanatory diagram briefly depicting an operation when a second place and subsequent places in the power-off order are set by using the dependency list table 42 in the present embodiment.

As depicted in FIG. 6, the power-off order generation unit 54 identifies, from the virtual machines 20 corresponding to the power-off target physical machine 10 in the virtual machine list table 41, a virtual machine 20 which does not exist in a column of the referent 42B within the dependency list table 42 corresponding to this power-off target physical machine 10, as the virtual machine 20 having a highest dependency.

The power-off order generation unit 54 sets this identified virtual machine 20 to the first place in the power-off order in the same power-off target physical machine 10. It should be noted that, in the power-off order generation unit 54, in the case of FIG. 6, the virtual machines 20 of “VM11” and “VM15” are set to the first place in the power-off order.

Next, when the power-off order generation unit 54 has set the first place in the power-off order in the power-off target physical machine 10, as depicted in FIG. 7, the power-off order generation unit 54 compares a column of the referrer 42A with the column of the referent 42B, excluding the dependencies of the virtual machines 20 set to this first place, within the dependency list table 42 corresponding to this power-off target physical machine 10.

The power-off order generation unit 54 identifies a virtual machine 20 which does not exist in the column of the referent 42B, from the virtual machines 20 in the column of the referrer 42A, as the virtual machine 20 having a higher dependency.

The power-off order generation unit 54 sets this identified virtual machine 20 to the second place in the power-off order. It should be noted that, in the power-off order generation unit 54, in the case of FIG. 7, the virtual machine 20 of “VM12” is set to the second place in the power-off order.

Furthermore, the power-off order generation unit 54 compares the column of the referrer 42A with the column of the referent 42B, excluding the dependencies of these virtual machines 20 set to the first place and the second place, and identifies a virtual machine 20 which does not exist in the column of the referent 42B, from the virtual machines 20 in the column of the referrer 42A, as the virtual machine 20 having the higher dependency.

The power-off order generation unit 54 sets this identified virtual machine 20 to a third place in the power-off order. It should be noted that, in the power-off order generation unit 54, in the case of FIG. 7, the virtual machine 20 of “VM13” is set to the third place in the power-off order. Furthermore, when the power-off order generation unit 54 repeats a similar process, the virtual machine 20 of “VM19” is set to a fourth place in the power-off order.

In other words, the power-off order generation unit 54 sequentially compares the column of the referrer 42A with the column of the referent 42B within the dependency list table 42, excluding the dependency of the virtual machine 20 which has already been set to any place, and based on a result of the comparison, generates the power-off order of the virtual machines 20 in the power-off target physical machine 10.

Furthermore, after setting all the virtual machines 20 being deployed on the power-off target physical machine 10 to the places in the power-off order, the power-off order generation unit 54 determines whether or not there is a virtual machine 20 which has the dependency on the virtual machine 20 on this power-off target physical machine 10 and is deployed on another physical machine 10.

The power-off order generation unit 54 includes a dependency determination unit 54A which, if there is the virtual machine 20 which has the dependency on the virtual machine 20 on the power-off target physical machine 10 and is deployed on another physical machine 10, determines whether or not this virtual machine 20 has the dependency on another virtual machine 20 other than the virtual machines 20 on the power-off target physical machine 10.

Moreover, the power-off order generation unit 54 includes a power-off order addition unit 54B which, if it is determined by the dependency determination unit 54A that the same virtual machine 20 has the dependency on another virtual machine 20 other than the virtual machines 20 on the power-off target physical machine 10, excludes this virtual machine 20 from the power-off target.

Moreover, if it is determined by the dependency determination unit 54A that the same virtual machine 20 has no dependency on another virtual machine 20 other than the virtual machines 20 on the power-off target physical machine 10, the power-off order addition unit 54B adds this virtual machine 20 to a predetermined place in the power-off order.

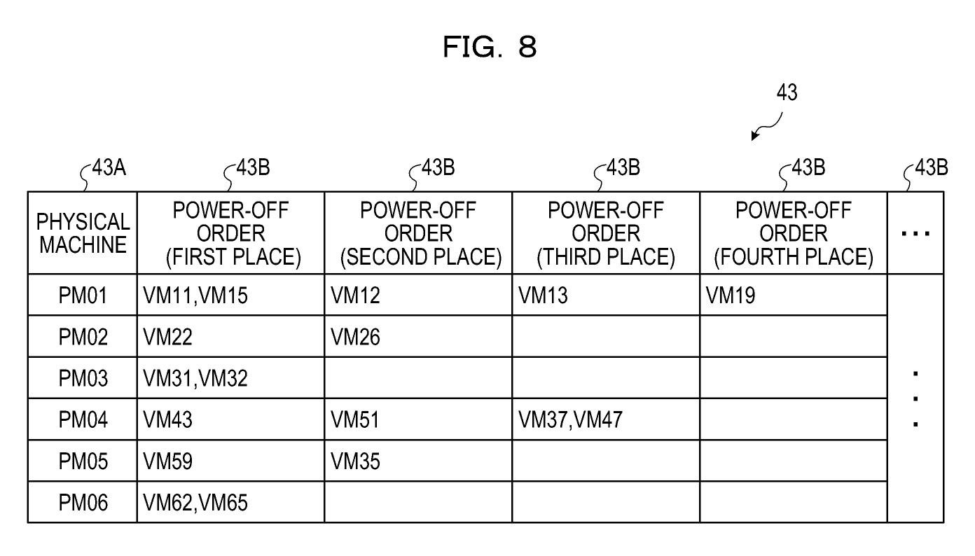

FIG. 8 is an explanatory diagram briefly depicting table contents of the power-off order management table 43 in the present embodiment.

The power-off order management table 43 depicted in FIG. 8 manages a power-off order 43B in units 43A of the physical machines 10. For example, in the case of the physical machine of “PM01”, the power-off order 43B is set and managed so that the virtual machines 20 of “VM11” and “VM15” are set to the first place, the virtual machine 20 of “VM12” is set to the second place, the virtual machine 20 of “VM13” is set to the third place, and the virtual machine 20 of “VM19” is set to the fourth place.

Moreover, the server management control unit 38 depicted in FIG. 2 includes a command screen presentation unit 55 which presents a command screen to the client 6 through the GUI unit 31, a target presentation unit 56 which, if an instruction for selecting the virtual machine 20 of the power-off target with respect to the virtual machines 20 on the command screen is detected, visually presents the power-off order of this virtual machine 20 of the power-off target and all the virtual machines 20 having the dependencies on the same virtual machine 20, to the client 6 through the GUI unit 31, and a virtual machine power control unit 57 which sequentially powers off the virtual machines 20 via the virtualization software control unit 36 based on this power-off order.

It should be noted that the virtual machine management unit 51, the virtual machine list generation unit 52, the dependency list generation unit 53, the power-off order generation unit 54, the command screen presentation unit 55, the target presentation unit 56 and the virtual machine power control unit 57 are performed, for example, by software processes on the server management control unit 38.

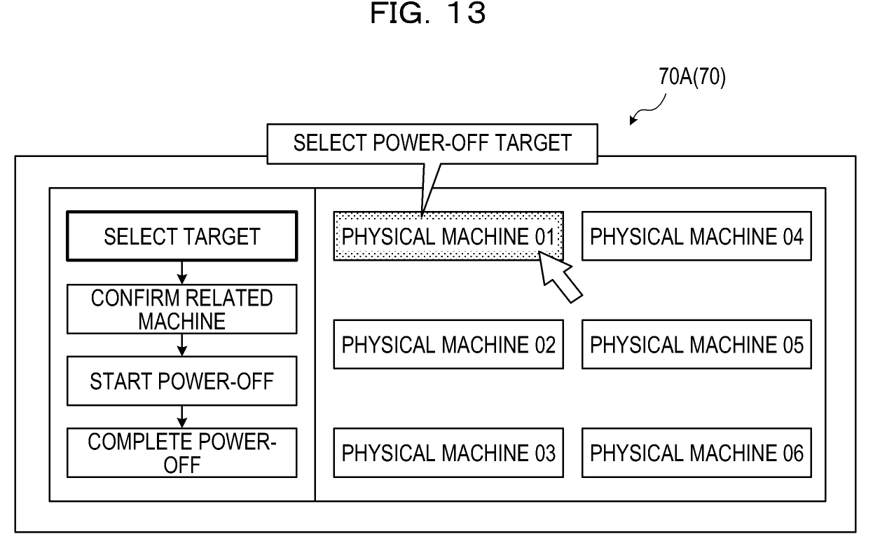

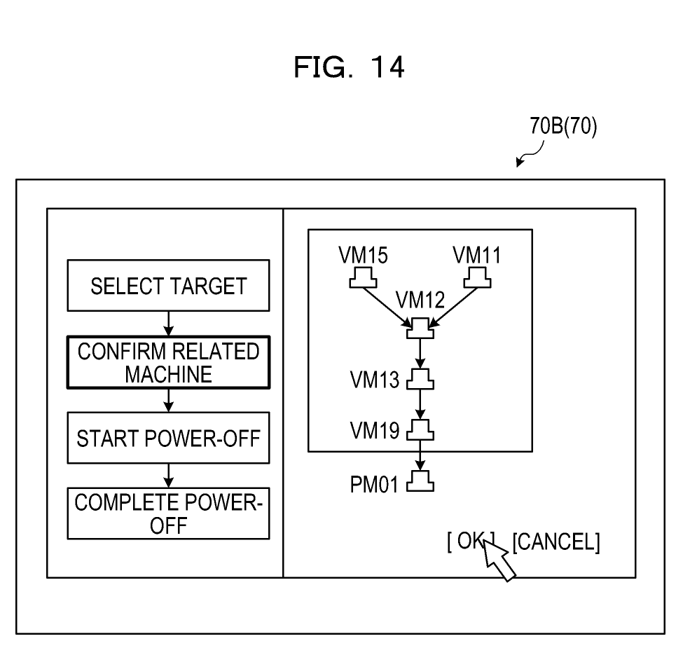

When a power-off start command from the client 6 is detected through the GUI unit 31, the command screen presentation unit 55 presents a power-off command screen 70 (see FIGS. 13 and 14) to the client 6.

When an instruction for selecting the power-off target physical machine 10 on the power-off command screen 70 is detected through the GUI unit 31, the target presentation unit 56 reads the power-off order in this power-off target based on the table contents of this power-off order management table 43, and presents this read power-off order (see FIG. 14) on the power-off command screen 70, to the client 6 through the GUI unit 31.

Moreover, when an instruction for selecting “OK” from the client 6 is detected through the GUI unit 31 while the power-off order regarding the power-off target virtual machines 20 is presented by the target presentation unit 56, the virtual machine power control unit 57 sequentially powers off the power-off target virtual machines 20 through the virtualization software control unit 36 based on this power-off order.

Moreover, when the power-off with respect to all the power-off target virtual machines 20 is completed by the virtual machine power control unit 57, the server management control unit 38 powers off the same power-off target physical machine 10 through the power control unit 35.

It should be noted that while the configurations of the embodiment have been described above, correspondence relationships between constituent features of the embodiment and those described in the claims will be described. A computer apparatus and a management server apparatus described in the claims correspond to the management server 5, the physical machine 10 corresponds to the host machine 3 or the storage apparatus 4, virtual machines described in the claims correspond to the virtual machines 20, a virtual machine list table described in the claims corresponds to the virtual machine list table 41, virtual machine list generation means described in the claims corresponds to the virtual machine list generation unit 52, a dependency list table described in the claims corresponds to the dependency list table 42, dependency list generation means described in the claims corresponds to the dependency list generation unit 53 and the virtualization software control unit 36, a power-off order management table described in the claims corresponds to the power-off order management table 43, power-off order generation means described in the claims corresponds to the power-off order generation unit 54, and power-off execution means described in the claims corresponds to the power control unit 35 and the virtual machine power control unit 57.

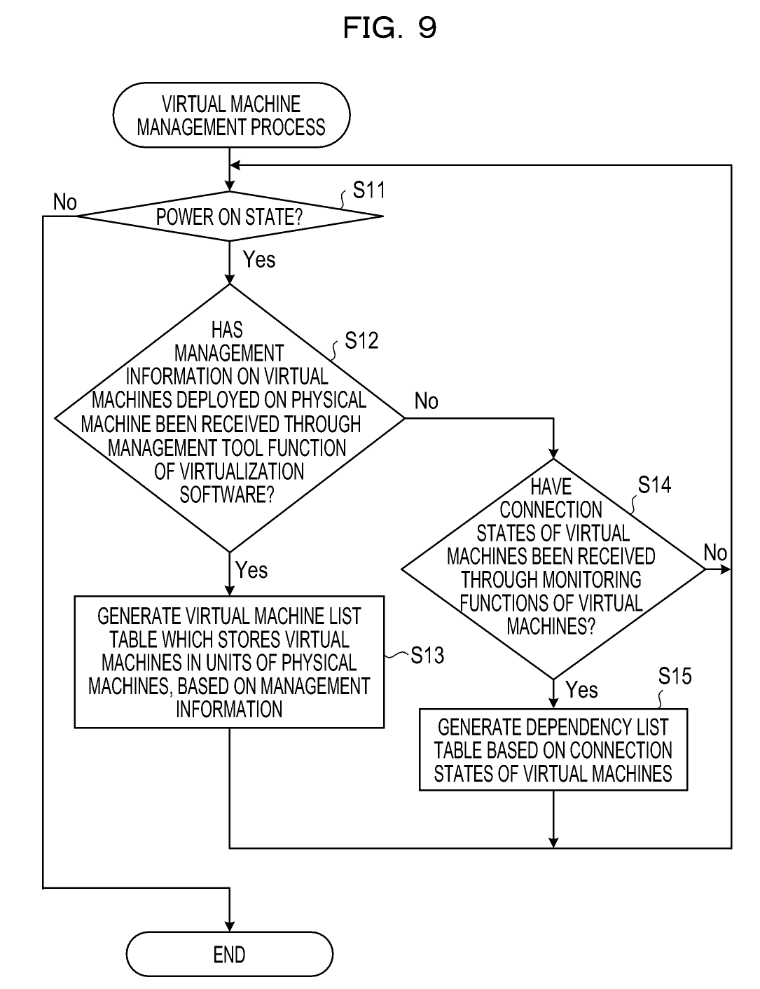

Next, operations of the virtual machine management system 1 of the present embodiment will be described. FIG. 9 is a flowchart depicting a processing operation of the server management control unit 38 within the management server 5, regarding a virtual machine management process in the present embodiment.

The virtual machine management process depicted in FIG. 9 is a process of generating the virtual machine list table 41 which manages the virtual machines 20 in units of the physical machines 10, and the dependency list table 42 which manages the dependencies among the virtual machines 20, in units of the physical machines 10, based on the connection states of the virtual machines 20.

In FIG. 9, the server management control unit 38 determines whether or not the management server 5 is in a power ON state (step S11).

If the management server 5 is in the power ON state (Yes at step S11), the server management control unit 38 determines whether or not the management information on the virtual machines 20 deployed on each physical machine 10 has been received through a management tool function of the virtualization software control unit 36 (step S12). It should be noted that the management tool function uses the management tool of the virtualization software to periodically collect the management information on the virtual machines 20 deployed on each physical machine 10.

If the management information on the virtual machines 20 has been received (Yes at step S12), based on this management information, the virtual machine list generation unit 52 in the server management control unit 38 generates the virtual machine list table 41 (see FIG. 4) which manages the plurality of virtual machines 20 deployed on the same physical machine 10, in units of the physical machines 10 (step S13), and the process proceeds to step S11 to monitor whether or not the management server 5 is in the power ON state.

Moreover, if the management information on the virtual machines 20 has not been received at step S12 (No at step S12), the server management control unit 38 determines whether or not the connection states of the virtual machines 20 have been received through the monitoring functions of the virtual machines 20 (step S14). It should be noted that the monitoring function of the virtual machine 20 periodically confirms the connection state of the virtual machine 20 itself.

If the connection states of the virtual machines 20 have been received (Yes at step S14), based on the connection states of the virtual machines 20, the dependency list generation unit 53 in the server management control unit 38 generates the dependency list table 42 (see FIG. 5) which manages the information on the connection destinations among the virtual machines 20 in a one-to-one manner in the list form (step S15), and the process proceeds to step S11 to monitor whether or not the management server 5 is in the power ON state.

Moreover, if the connection states of the virtual machines 20 have not been received at step S14 (No at step S14), the server management control unit 38 proceeds to step S11.

Moreover, if the management server 5 is not in the power ON state at step S11 (No at step S11), the server management control unit 38 completes this processing operation.

According to the virtual machine management process depicted in FIG. 9, when, for each physical machine 10, the management information on the virtual machines 20 deployed on the same physical machine 10 is periodically received through the management tool function of the virtualization software control unit 36, the virtual machine list table 41 which manages the virtual machines 20 deployed on the same physical machine 10, in the list form in units of the physical machines 10 is generated, and also, when the connection states of the virtual machines 20 are received through the monitoring functions of the virtual machines 20, based on these connection states, the dependency list table 42 which manages the information on the connection destinations among the same virtual machines 20 in a one-to-one manner and thereby manages the dependencies among the virtual machines 20 in the list form in units of the physical machines 10 is generated. Therefore, on the management server 5 side, based on the table contents of the virtual machine list table 41, the virtual machines 20 deployed on each physical machine 10 can be recognized, and also, based on the table contents of the dependency list table 42, the dependencies among the respective virtual machines 20 can be recognized in units of the physical machines 10.

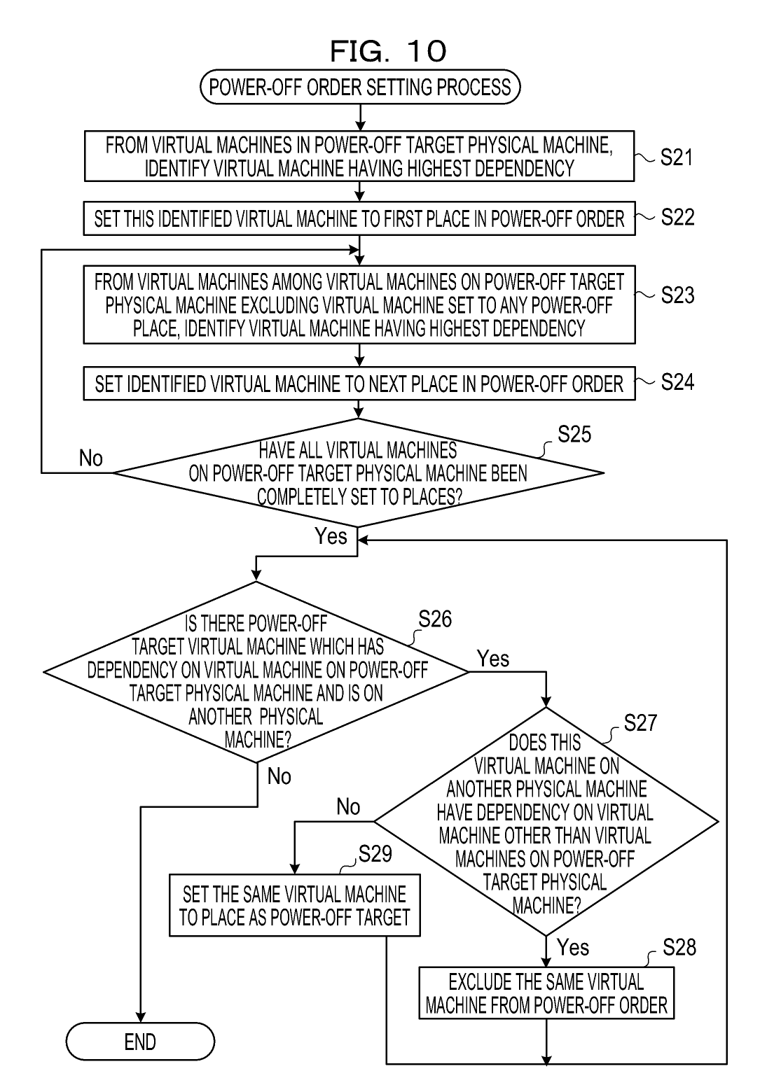

Next, a power-off order setting process in the present embodiment will be described. FIG. 10 is a flowchart depicting a processing operation of the server management control unit 38 within the management server 5, regarding the power-off order setting process in the present embodiment.

The power-off order setting process depicted in FIG. 10 is a process of setting the power-off order in which, for each physical machine 10, of course, the virtual machines 20 deployed on the same physical machine 10, and depending on conditions, also the virtual machines 20 having the dependencies on the same virtual machines 20 are sequentially powered off.

In FIG. 10, the power-off order generation unit 54 in the server management control unit 38 identifies the virtual machine 20 having the highest dependency, in units of the physical machines 10, based on the table contents of the virtual machine list table 41 and the dependency list table 42 (step S21).

It should be noted that, as depicted in FIG. 6, the power-off order generation unit 54 compares the virtual machine list table 41 of the power-off target physical machine 10 with the referent 42B in the dependency list table 42 of the same power-off target physical machine 10, and identifies the virtual machine 20 which does not exist in the column of the referent 42B in the dependency list table 42, from the virtual machines 20 being deployed on the power-off target physical machine 10, as the virtual machine 20 having the highest dependency.

The power-off order generation unit 54 sets the virtual machine 20 having the highest dependency at step S21 to the first place in the power-off order (step S22), and identifies the virtual machine 20 having the highest dependency, from the virtual machines 20 on the power-off target physical machine 10 in a state where the dependency of the virtual machine 20 which has already been set to any power-off place has been excluded (step S23). It should be noted that the power-off order generation unit 54 sets and manages the places in the power-off order, in the power-off order management table 43, in a manner corresponding to the virtual machine 20 having the highest dependency.

Moreover, at step S23, the power-off order generation unit 54 compares the column of the referrer 42A with the column of the referent 42B in the dependency list table 42 depicted in FIG. 7, in a state where the dependency of the virtual machine 20 which has already been set to any power-off place has been excluded from the column of the referrer 42A and the column of the referent 42B, and identifies the virtual machine 20 which does not exist in the column of the referent 42B, from the virtual machines 20 in the column of the referrer 42A, as the virtual machine 20 having the higher dependency.

The power-off order generation unit 54 sets the virtual machine 20 identified at step S23 to a next place in the power-off order (step S24). It should be noted that the next place means that the place of the power-off target which has been immediately previously set is incremented by 1.

When the power-off order generation unit 54 has set the virtual machine 20 to the next place in the power-off order at step S24, the power-off order generation unit 54 determines whether or not all the virtual machines 20 on the power-off target physical machine 10 have been completely set to the places in the power-off order (step S25).

If all the virtual machines 20 on the power-off target physical machine 10 have not been completely set to the places in the power-off order (No at step S25), the power-off order generation unit 54 proceeds to step S23 to identify the virtual machine 20 having a next highest dependency. It should be noted that, as a result thereof, in the dependencies depicted in FIG. 3, if it is assumed that the power-off target physical machine 10 is “PM01”, the power-off order is set so that “VM11” and “VM15” are set to the first place, “VM12” is set to the second place, “VM13” is set to the third place, and “VM19” is set to the fourth place.

If all the virtual machines 20 on the power-off target physical machine 10 have been completely set to the places in the power-off order (Yes at step S25), the power-off order generation unit 54 determines whether or not there is the virtual machine 20 which has the dependency on the virtual machine 20 on the power-off target physical machine 10 and is on another physical machine 10, based on the table contents of the dependency list table 42 corresponding to the power-off target physical machine 10, through the dependency determination unit 54A (step S26).

If there is no virtual machine 20 which has the dependency on the virtual machine 20 on the power-off target physical machine 10 and is on another physical machine 10 (No at step S26), the power-off order generation unit 54 completes this processing operation.

If there is the virtual machine 20 which has the dependency on the virtual machine 20 on the power-off target physical machine 10 and is on another physical machine 10 (Yes at step S26), for example, as depicted in FIGS. 3 and 5, if there is the virtual machine 20 of “VM22” which has the dependency on the virtual machine 20 of “VM11” on the power-off target physical machine 10 of “PM01” and is on the physical machine 10 of “PM02”, the power-off order generation unit 54 determines whether or not this virtual machine 20 on another physical machine 10 has the dependency on the virtual machine 20 other than the virtual machines 20 on the power-off target physical machine 10 (step S27).

If the virtual machine 20 on another physical machine 10 has the dependency on the virtual machine 20 other than the virtual machines 20 on the power-off target physical machine 10 (Yes at step S27), for example, as depicted in FIGS. 3 and 5, if the virtual machine 20 of “VM22” on the physical machine 10 of “PM02” has the dependency on the virtual machine 20 of “VM26” other than the virtual machines 20 on the power-off target physical machine 10 of “PM01”, the power-off order generation unit 54 excludes the virtual machine 20 of “VM22” from the power-off order in the power-off target physical machine 10, through the power-off order addition unit 54B (step S28).

When the power-off order generation unit 54 has excluded the virtual machine 20 of “VM22” from the power-off order at step S28, the power-off order generation unit 54 proceeds to step S26 to determine whether or not there is further the virtual machine 20 which has the dependency on the virtual machine 20 on the power-off target physical machine 10 and is on another physical machine 10.

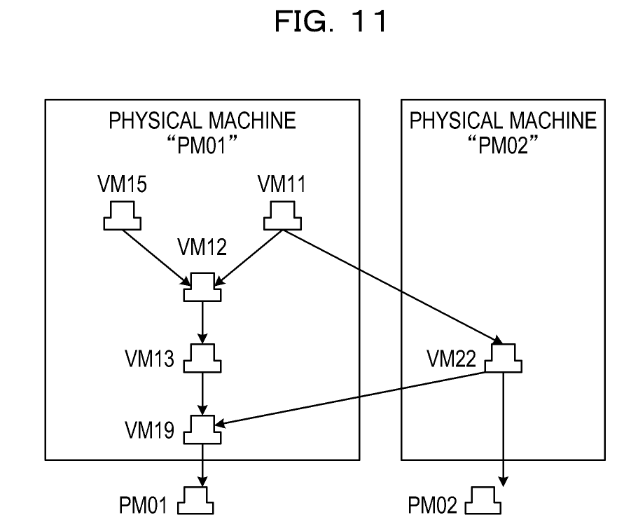

Moreover, if the virtual machine 20 on another physical machine 10 has no dependency on the virtual machine 20 other than the virtual machines 20 on the power-off target physical machine 10 (No at step S27), for example, as depicted in FIG. 11, if the virtual machine 20 of “VM22” on the physical machine 10 of “PM02” has no dependency on the virtual machine 20 other than the virtual machines 20 on the power-off target physical machine 10 of “PM01”, the power-off order generation unit 54 sets this virtual machine 20 (“VM22” in the case of FIG. 11) to the predetermined place in the power-off order so as to set this virtual machine 20 as the power-off target, through the power-off order addition unit 54B (step S29). It should be noted that the predetermined place is assumed to be set, for example, to a lowest place in the power-off places.

When the power-off order generation unit 54 has set the virtual machines 20 (“VM22” in the case of FIG. 11) to the predetermined place as the power-off target at step S29, the power-off order generation unit 54 proceeds to step S26 to determine whether or not there is further the virtual machine 20 which has the dependency on the virtual machine 20 on the power-off target physical machine 10 and is on another physical machine 10.

According to the power-off order setting process depicted in FIG. 10, based on the table contents of the virtual machine list table 41 and the dependency list table 42, the places in the power-off order of the virtual machines 20 are set in descending order of dependency, in units of the physical machines 10. Therefore, the places in the power-off order can be automatically set in descending order of dependency.

Moreover, according to the power-off order setting process, even in the case where the virtual machine 20 deployed on the power-off target physical machine 10 has the dependency on the virtual machine 20 on another physical machine 10, if this virtual machine 20 on another physical machine 10 has the dependency on the virtual machine 20 other than the virtual machines 20 on the power-off target physical machine 10, the same virtual machine 20 is excluded from the power-off order. Therefore, an effect of the power-off of the virtual machine 20 having the dependency on the virtual machine 20 deployed on the power-off target physical machine 10 can be prevented from occurring.

Moreover, according to the power-off order setting process, even in the case where the virtual machine 20 deployed on the power-off target physical machine 10 has the dependency on the virtual machine 20 on another physical machine 10, if this virtual machine 20 on another physical machine 10 has no dependency on the virtual machine 20 other than the virtual machines 20 on the power-off target physical machine 10, the same virtual machine 20 is added to the predetermined place in the power-off order. Therefore, the virtual machine 20 having the dependency on the virtual machine 20 deployed on the power-off target physical machine 10 can also be set to the predetermined place in the power-off order.

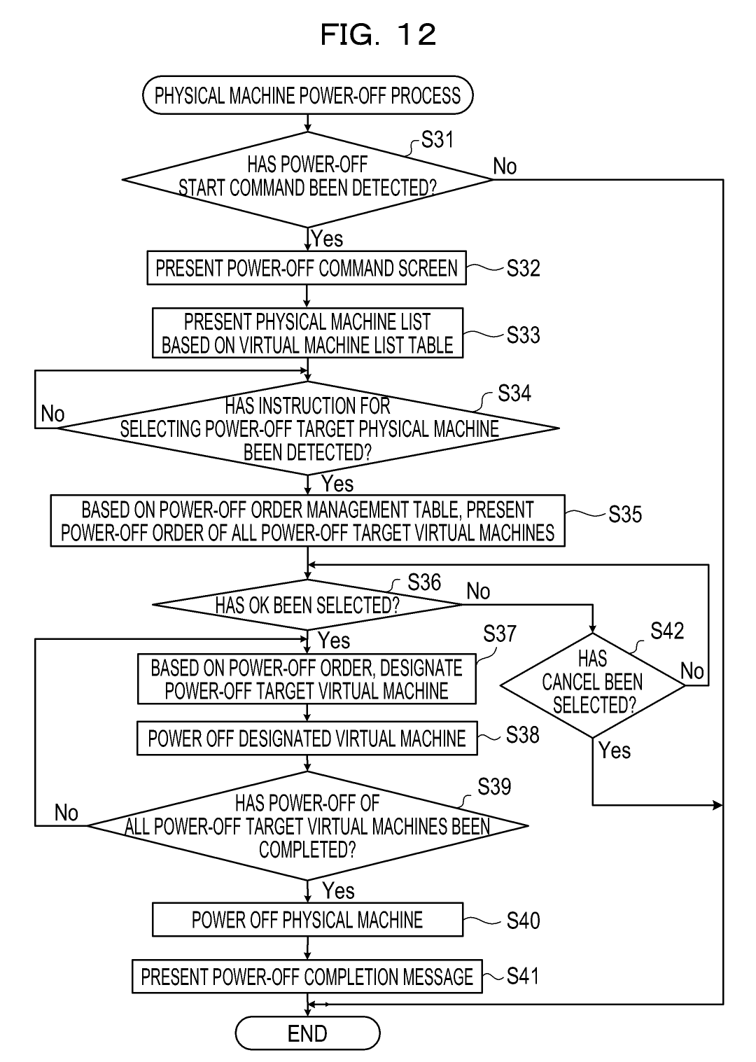

Next, a physical machine power-off process in the present embodiment will be described. FIG. 12 is a flowchart depicting a processing operation of the server management control unit 38 within the management server 5, regarding the physical machine power-off process in the present embodiment.

The physical machine power-off process depicted in FIG. 12 is a process of, when the instruction for selecting the power-off target physical machine 10 is detected, sequentially powering off, of course, the power-off target physical machine 10 and the virtual machines 20 deployed on this physical machine 10, and depending on the conditions, also the virtual machines 20 having the dependencies on these power-off target virtual machines 20, based on the power-off order.

In FIG. 12, the server management control unit 38 determines whether or not the power-off start command from the client 6 has been detected through the GUI unit 31 (step S31).

If the power-off start command has been detected (Yes at step S31), the command screen presentation unit 55 in the server management control unit 38 presents the power-off command screen 70 depicted in FIG. 13 to the client 6 through the GUI unit 31 (step S32).

Moreover, based on the table contents of the virtual machine list table 41, the target presentation unit 56 in the server management control unit 38 presents the physical machines 10 being managed by this management server 5, on the power-off command screen 70 (step S33). It should be noted that a user on the client 6 side can visually recognize the physical machines 10 being managed by the management server 5, that is, the power-off target physical machines 10, based on contents presented on a power-off command screen 70A depicted in FIG. 13.

The server management control unit 38 determines whether or not the instruction for selecting the power-off target physical machine 10 has been detected on the power-off command screen 70A through the GUI unit 31 (step S34).

If the instruction for selecting the power-off target physical machine 10 has been detected (Yes at step S34), based on the table contents of the power-off order management table 43, the target presentation unit 56 in the server management control unit 38 presents the power-off order in the power-off target physical machine 10, on the power-off command screen 70 through the GUI unit 31, as depicted in FIG. 14 (step S35). It should be noted that the user on the client 6 side can visually recognize the dependencies among all the power-off target virtual machines 20, based on screen contents of a power-off command screen 70B depicted in FIG. 14.

The server management control unit 38 determines whether or not the instruction for selecting “OK” from the client 6 on the power-off command screen 70B so as to request execution of the power-off of all the power-off target virtual machines 20 being currently presented has been detected through the GUI unit 31 (step S36).

If the instruction for selecting “OK” has been detected (Yes at step S36), based on the table contents of the power-off order management table 43, the virtual machine power control unit 57 in the server management control unit 38 designates the virtual machine 20 at a higher place among all these power-off target virtual machines 20 based on the power-off order (step S37), and powers off the same virtual machine 20 in a software manner through the virtualization software control unit 36 (step S38). It should be noted that if a plurality of power-off target virtual machines 20 have been designated at step S37, the plurality of virtual machines 20 are simultaneously powered off in a process at step S38.

When the virtual machine power control unit 57 has powered off the virtual machine 20 in a software manner at step S38, the virtual machine power control unit 57 determines whether or not the power-off of all the virtual machines 20 related to the power-off target physical machine 10 has been completed (step S39).

If the power-off of all the virtual machines 20 related to the power-off target physical machine 10 has been completed (Yes at step S39), the power control unit 35 powers off this power-off target physical machine 10 through the machine side power control unit 3B of the same physical machine 10 (step S40).

When the target presentation unit 56 has detected the power-off of the power-off target physical machine 10, the target presentation unit 56 presents a power-off completion message to the client 6 through the GUI unit 31 (step S41). The power-off completion message indicates that the power-off of, of course, this power-off target physical machine 10, and all the virtual machines 20 related to the physical machine 10, based on the power-off order, has been completed. Thereby, this processing operation is completed. It should be noted that the user on the client 6 side can recognize that the power-off of the power-off target physical machine 10 has been completed, based on the power-off completion message.

Moreover, if the power-off of all the virtual machines 20 related to the power-off target physical machine 10 has not been completed at step S39 (No at step S39), the virtual machine power control unit 57 proceeds to step S37 to designate the virtual machine 20 at the next place to be powered off next, based on the power-off order.

Moreover, if the instruction for selecting “OK” from the client 6 on the power-off command screen 70B has not been detected at step S36 (No at step S36), the server management control unit 38 determines whether or not an instruction for selecting “cancel” on the power-off command screen 70B has been detected (step S42).

If the instruction for selecting “cancel” on the power-off command screen 70B has been detected (Yes at step S42), the server management control unit 38 completes this processing operation.

Moreover, if the instruction for selecting “cancel” has not been detected at step S42 (No at step S42), the server management control unit 38 proceeds to step S36 to determine whether or not the instruction for selecting “OK” has been detected.

Moreover, if the power-off start command has not been detected at step S31 (No at step S31), the server management control unit 38 completes this processing operation.

Moreover, if the instruction for selecting the power-off target virtual machine 20 has not been detected at step S34 (No at step S34), the server management control unit 38 continues a monitoring operation at step S34 to monitor the detection of the instruction for selecting the power-off target virtual machine 20.

According to the physical machine power-off process depicted in FIG. 12, when the instruction for selecting the power-off target physical machine 10 is detected, based on the table contents of the power-off order management table 43, the power-off order corresponding to this power-off target physical machine 10 is visually presented to the client 6 side. Therefore, the user on the client 6 side can visually recognize the power-off order of the virtual machines 20 related to the power-off target physical machine 10, based on presented contents thereof.

Moreover, according to the physical machine power-off process, if the instruction for selecting “OK” with respect to this power-off order has been detected while the power-off order of the virtual machines 20 related to the power-off target physical machine 10 is presented, the power-off target virtual machines 20 are sequentially powered off in descending order of dependency, based on this power-off order, and the power-off target physical machine 10 is finally powered off. Therefore, even if there are a plurality of virtual machines 20 having the dependencies among them, the plurality of virtual machines 20 having the dependencies among them can be powered off in a simple operation. Accordingly, it is possible to intend, of course, to reduce a work time required for the power-off, and also to significantly reduce a work burden thereof.

According to the present embodiment, based on the table contents of the virtual machine list table 41 and the dependency list table 42, from the virtual machines 20 deployed on the power-off target physical machine 10 and the virtual machines 20 having the dependencies on these virtual machines 20, the power-off order management table 43 which manages the power-off order in which the same virtual machines 20 are sequentially powered off in descending order of dependency, in units of the physical machines 10, is generated. Based on the table contents of this power-off order management table 43, when the instruction for selecting the power-off target physical machine 10 is detected, the power-off order corresponding to this power-off target physical machine 10 is visually presented. Therefore, even the user other than the specific system administrator can identify the power-off order in the power-off target physical machine 10 based on the presented contents thereof, and thereby easily power off this power-off target physical machine 10 including the virtual machines 20 dependent on the power-off target physical machine 10, without any complicated operational burden.

Moreover, according to the present embodiment, when the instruction for selecting “OK” is detected while the power-off order indicating the dependencies among all the virtual machines 20 related to the power-off target physical machine 10 is presented, the virtual machines 20 are sequentially powered off in descending order of dependency, based on this power-off order. Therefore, since all these power-off target virtual machines 20 can be sequentially powered off in the simple operation, it is possible to intend to significantly reduce the work burden of the power-off while the reduction in the work time required for the power-off is intended.

Moreover, according to the present embodiment, even in the case where the virtual machine 20 deployed on the power-off target physical machine 10 has the dependency on the virtual machine 20 on another physical machine 10, if this virtual machine 20 on another physical machine 10 has the dependency on the virtual machine 20 other than the virtual machines 20 on the power-off target physical machine 10, the same virtual machine 20 is excluded from the power-off order. Therefore, the effect of the power-off of the virtual machine 20 having the dependency on the virtual machine 20 deployed on the power-off target physical machine 10 can be prevented from occurring.

Moreover, according to the present embodiment, even in the case where the virtual machine 20 deployed on the power-off target physical machine 10 has the dependency on the virtual machine 20 on another physical machine 10, if this virtual machine 20 on another physical machine 10 has no dependency on the virtual machine 20 other than the virtual machines 20 on the power-off target physical machine 10, the same virtual machine 20 is added to the predetermined place in the power-off order. Therefore, the virtual machine 20 having the dependency on the virtual machine 20 deployed on the power-off target physical machine 10 can also be set to the predetermined place in the power-off order.

It should be noted that, in the present embodiment, based on the table contents of the power-off order management table 43, when the instruction for selecting “OK” is detected while the power-off order indicating the dependencies among all the virtual machines 20 related to the power-off target physical machine 10 is presented, all the virtual machines 20 related to the power-off target physical machine 10 and the physical machine 10 are automatically powered off, while, of course, the virtual machines 20 and the physical machine 10 of the power-off targets may be manually and sequentially powered off.

Moreover, in the present embodiment, the virtual machine management system 1 in cooperation with the plurality of virtual machines 20 deployed on a plurality of physical machines 10 has been described by way of example. However, of course, a system in which the plurality of virtual machines 20 deployed on one physical machine 10 cooperate with one another can also provide a similar advantageous effect.

Moreover, in the present embodiment, in the power-off order setting process depicted in FIG. 10, the power-off order is previously managed in the power-off order management table 43, in units of the power-off target physical machines 10. However, of course, the similar advantageous effect can also be provided if, for example, at a timing when the instruction for selecting the power-off target physical machine 10 on the power-off command screen 70A has been detected at step S34 depicted in FIG. 12, the power-off order setting process of setting the power-off order of the virtual machines 20 related to the power-off target physical machine 10 is executed, and the power-off order is managed in the power-off order management table 43, in units of the physical machines 10.

Moreover, in the present embodiment, it has been described that the virtual machine 20 (“VM22” in the case of FIG. 11) is set to the lowest place in the power-off order, as the predetermined place in the power-off order, at step S29 of FIG. 10. However, of course, the place in the power-off order may be set in consideration of the dependency between the virtual machine 20 on the power-off target physical machine 10 and the same virtual machine 20 of “VM22”.

Moreover, in the present embodiment, the physical machine 10 is powered off by controlling the machine side power control unit 3B in the physical machine 10 through the power control unit 35 in the management server 5. However, for example, if the physical machine 10 controls its power through an uninterruptible power supply apparatus, of course, the uninterruptible power supply apparatus is controlled through the power control unit 35 to power off the physical machine 10.

Moreover, in the present embodiment, the virtual machines 20 related to the power-off target physical machine 10 are powered off in descending order of dependency, that is, based on the power-off order. However, the virtual machine 20 having no dependency is directly powered off, which, of course, can reduce a time required for a power-off task.

Hereinabove, although the embodiment of the present invention has been described, the range of the technical idea of the present invention is not limited by the present embodiment, and of course, various embodiments can be practiced as long as those embodiments do not deviate from the range of the technical idea described in the claims. Moreover, the advantageous effects described in the present embodiment are not limited thereto.

Moreover, among the various processes described in the present embodiment, of course, all or some of the processes described to be automatically performed can also be manually performed, and conversely, of course, all or some of the processes described to be manually performed can also be automatically performed. Moreover, of course, processing procedures, control procedures, specific names, and information including various data or parameters, which have been described in the present embodiment, can also be altered as appropriate, if not otherwise specified.

Moreover, respective components of respective apparatuses depicted in the drawings have been described in terms of functional concepts, and are not necessarily physically configured as depicted in the drawings, and of course, specific aspects of the respective apparatuses are never limited or reduced to those depicted in the drawings.

Furthermore, of course, all of various processing functions performed in the respective apparatuses, or arbitrarily, some of those may be executed on a CPU (Central Processing Unit) (or a microcomputer such as an MPU (Micro Processing Unit) or an MCU (Micro Controller Unit)), on a program which is analyzed and executed by the same CPU (or the microcomputer such as the MPU or the MCU), or on hardware with wired logic.

What is claimed is:

1. A recording medium having recorded therein a virtual machine management program for causing a computer apparatus which causes arbitrary virtual machines among a plurality of virtual machines deployed on a physical machine to execute a control process in cooperation with one another, to execute a process of managing the plurality of virtual machines, the virtual machine management program causing the computer apparatus to execute:
a virtual machine detection procedure for detecting the virtual machines deployed on the physical machine,
a virtual machine list generation procedure for, based on a result of the detection by the virtual machine detection procedure, generating a virtual machine list table which manages virtual machine identification information for identifying the virtual machines deployed on the physical machine;
a dependency detection procedure for detecting dependencies among the virtual machines deployed on the physical machine;
a dependency list generation procedure for, based on a result of detection by the dependency detection procedure, generating a dependency list table which manages the dependence of the virtual machine identification information;
a power-off order generation procedure for, based on table contents of the virtual machine list table and the dependency list table, from the virtual machines deployed on the physical machine of a power-off target and the virtual machines having the dependencies on these virtual machines, generating a power-off order management table which manages a power-off order in which the same virtual machines are sequentially powered off in descending order of dependency, in units of said physical machine; and
a target presentation procedure for, when an instruction for selecting the power-off target physical machine is detected, reading the power-off order corresponding to the power-off target physical machine from the power-off order management table, and visually presenting the read power-off order.

2. The recording medium having recorded therein the virtual machine management program according to claim 1, wherein said virtual machine management program causes said computer apparatus to execute a power-off execution procedure for, when an instruction for starting said power-off is detected while the power-off order corresponding to said power-off target physical machine is presented in said target presentation procedure, based on said power-off order, sequentially powering off the virtual machines on said power-off target physical machine and the virtual machines having the dependencies on these virtual machines, and subsequently, powering off this power-off target physical machine.

3. The recording medium having recorded therein the virtual machine management program according to claim 2, wherein said power-off order generation procedure causes said computer apparatus to execute:
a dependency determination procedure for, if there is a virtual machine deployed on another physical machine, among the virtual machines having the dependencies on the virtual machines deployed on said power-off target physical machine, determining whether or not this virtual machine deployed on another physical machine has the dependency on another virtual machine other than the virtual machines deployed on said power-off target physical machine; and
a power-off order exclusion procedure for, in this dependency determination procedure, if said virtual machine deployed on another physical machine has the dependency on another virtual machine other than the virtual machines deployed on said power-off target physical machine, excluding this virtual machine from said power-off target.

4. The recording medium having recorded therein the virtual machine management program according to claim 3, wherein said power-off order generation procedure causes said computer apparatus to execute:
a power-off order addition procedure for, in said dependency determination procedure, if said virtual machine deployed on another physical machine has no dependency on another virtual machine other than the virtual machines deployed on said power-off target physical machine, adding this virtual machine as said power-off target to said power-off order.

5. A management server apparatus which manages a physical machine, also manages a plurality of virtual machines deployed on this physical machine, and enables arbitrary virtual machines among the plurality of virtual machines to execute a control process in cooperation with one another, the server comprising:
a virtual machine detector for detecting the virtual machines deployed on the physical machine,
a virtual machine list generator for, based on a result of the detection by the virtual machine detector, generating a virtual machine list table which manages virtual machine identification information for identifying the virtual machines deployed on the physical machine;
a dependency detector for detecting dependencies among the virtual machines deployed on the physical machine;
a dependency list generator for, based on a result of detection by the dependency detector, generating a dependency list table which manages the dependence of the virtual machine identification information;
a power-off order generator for, based on table contents of the virtual machine list table and the dependency list table, from the virtual machines deployed on the physical machine of a power-off target and the virtual machines having the dependencies on these virtual machines, generating a power-off order management table which manages a power-off order in which the same virtual machines are sequentially powered off in descending order of dependency, in units of said physical machine; and
a target presentation unit for, when an instruction for selecting the power-off target physical machine is detected, reading the power-off order corresponding to the power-off target physical machine from the power-off order management table, and visually presenting the read power-off order.

6. The management server apparatus according to claim 5, further comprising:
power-off execution unit for, when an instruction for starting said power-off is detected while the power-off order corresponding to the power-off target physical machine is presented by the target presentation unit, based on the power-off order, sequentially powers off the virtual machines on the power-off target physical machine and the virtual machines having the dependencies on these virtual machines, and subsequently, powers off this power-off target physical machine.

7. The management server apparatus according to claim 6, wherein the power-off order generator comprises:
dependency determination unit which, if there is a virtual machine deployed on another physical machine, among the virtual machines having the dependencies on the virtual machines deployed on said power-off target physical machine, determines whether or not this virtual machine deployed on another physical machine has the dependency on another virtual machine other than the virtual machines deployed on said power-off target physical machine; and
power-off order exclusion unit which, in this dependency determination means, if the virtual machine deployed on another physical machine has the dependency on another virtual machine other than the virtual machines deployed on said power-off target physical machine, excludes this virtual machine from said power-off target.

8. The management server apparatus according to claim 7, wherein said power-off order generation means further comprises:
power-off order addition unit which, in the dependency determination means, if the virtual machine deployed on another physical machine has no dependency on another virtual machine other than the virtual machines deployed on the power-off target physical machine, adds the virtual machine as the power-off target to the power-off order.

9. A virtual machine management method which enables arbitrary virtual machines among a plurality of virtual machines deployed on a physical machine to execute a control process in cooperation with one another, and manages said plurality of virtual machines, the method comprising:
a virtual machine detection procedure for detecting the virtual machines deployed on the physical machine,
a virtual machine list generation procedure for, based on a result of the detection by the virtual machine detection procedure, generating a virtual machine list table which manages virtual machine identification information for identifying the virtual machines deployed on the physical machine;
a dependency detection procedure for detecting dependencies among the virtual machines deployed on the physical machine;
a dependency list generation procedure for, based on a result of detection by the dependency detection procedure, generating a dependency list table which manages the dependence of the virtual machine identification information;
a power-off order generation procedure for, based on table contents of the virtual machine list table and the dependency list table, from the virtual machines deployed on the physical machine of a power-off target and the virtual machines having the dependencies on these virtual machines, generating a power-off order management table which manages a power-off order in which the same virtual machines are sequentially powered off in descending order of dependency, in units of said physical machine; and
a target presentation procedure for, when an instruction for selecting the power-off target physical machine is detected, reading the power-off order corresponding to the power-off target physical machine from the power-off order management table, and visually presenting the read power-off order.

10. The virtual machine management method according to claim 9, further comprising:
a power-off execute procedure, when an instruction for starting said power-off is detected while the power-off order corresponding to the power-off target physical machine is presented at the target presentation procedure, based on the power-off order, sequentially powering off the virtual machines on the power-off target physical machine and the virtual machines having the dependencies on these virtual machines, and subsequently, powering off this power-off target physical machine.
